(19) United States
(12) Patent Application Publication
(10) Pub. No.: US 2024/0298562 A1
(43) Pub. Date: Sep. 12, 2024

(54) AUTONOMOUS TRACTOR SYSTEM

(71) Applicant: MOVE ON TEKNOLOJI ANONIM SIRKETI, Istanbul (TR)

(72) Inventor: Omer Faruk KOC, Istanbul (TR)

(73) Assignee: MOVE ON TEKNOLOJI ANONIM SIRKETI, Istanbul (TR)

(21) Appl. No.: 18/273,035

(22) PCT Filed: Nov. 15, 2021
(86) PCT No.: PCT/TR2021/051207

§ 371 Date: Jul. 19, 2023

(30) Foreign Application Priority Data
Mar. 1, 2021 (TR) 2021/003997

(51) Int. Cl. A01B 69/04; A01B 49/06; B60K 35/22; G06V 10/774; G06V 20/10; G06V 20/58; G06V 20/68

(52) U.S. Cl. CPC A01B 69/008; A01B 49/06; B60K 35/22; G06V 10/774; G06V 20/188; G06V 20/58; G06V 20/68; B60K 2360/166; B60K 2360/785

(57) ABSTRACT

An artificial intelligence based autonomous tractor system for use in agricultural areas includes a tractor, a steering wheel for providing guidance of the tractor to a determined direction, and a drive element embodied for electro-hydraulic steering wheel manipulation and including an open cycle hydraulic circuit which provides guidance of the steering wheel to the determined direction for providing movement of the steering wheel, in order to provide autonomous movement of the tractor.

### CROSS REFERENCE TO THE RELATED APPLICATIONS

This application is the national phase entry of International Application No. PCT/TR2021/051207, filed on Nov. 15, 2021, which is based upon and claims priority to Turkish Patent Application No. 2021/003997, filed on Mar. 1, 2021, the entire contents of which are incorporated herein by reference.

### TECHNICAL FIELD

The present invention relates to an artificial intelligence based autonomous tractor system for use in agricultural areas and for providing autonomous movement of a tractor.

### BACKGROUND

Tractors are used for various purposes on agricultural areas like pushing, drawing, carrying, digging, transferring, planting, pricking, hoeing, agricultural spraying, fertilizing, etc. Tractors are separated according to usage areas. The most frequent usage area is agricultural tractors which provide realization of hoeing, planting, pricking, etc. processes in the agricultural field. Usage of tractors is similar to the usage of automobiles. However, since tractors are terrain vehicles, they do not have the comfort provided to automobiles. The driver becomes tired in a short time because of bouncing, prancing, etc. conditions depending on movement of the tractor in accordance with the condition of the terrain. Lack of attention occurs depending on the tiredness of the driver. Lack of attention can lead to environmental pollution depending on applying of the wrong pesticide to the wrong place, and reduction in efficiency depending on wrongly plowing of the terrain, and an accident which can occur because of not being able to recognize an obstacle. These may lead to time loss and occurrence of environmental wastes and monetary losses.

In recent times, automatic usage of objects increases as technology develops. The need for human power decreases further every passing day. One of the developed automatic technologies is the autonomous vehicles. Autonomous vehicles are vehicles which sense the path, traffic flow and periphery thereof without needing a driver thanks to the automatic control systems provided therein, and which can go in cruise without the intervention of the driver. Systems which operate autonomously have been begun to be used in agriculture field in recent times. Systems, provided to tractor operated autonomously in accordance with the usage area, are known in the present art.

In the present art, there are systems which are operated partially autonomously and which provide decrease of the work load of the tractor driver. However, systems which have camera equipment and artificial intelligence software which can provide autonomy by viewing like the driver and which provide completely automatic usage of the tractor depending on the desire of the driver and which can provide compliancy to the new technology by continuously updating itself are not known in the present art.

As a result, because of the abovementioned problems, an improvement is required in the related technical field.

### SUMMARY

The present invention relates to an artificial intelligence based autonomous tractor system, for eliminating the abovementioned disadvantages and for bringing new advantages to the related technical field.

An object of the present invention is to provide an autonomous tractor system which provides completely automatic controlling of the tractor in an independent manner from the driver.

In order to realize the abovementioned objects and the objects which are to be deducted from the detailed description below, the present invention is an artificial intelligence based autonomous tractor system for use in agricultural areas, comprising a tractor, a steering wheel for providing guidance of said tractor to a determined direction, and a drive element embodied for electro-hydraulic steering wheel manipulation and comprising an open cycle hydraulic circuit which provides guidance of said steering wheel to the determined direction for providing movement of said steering wheel, in order to provide autonomous movement of said tractor. Accordingly, the improvement is that the subject matter comprises an imaging unit for capturing images from the said tractor; a sensing unit provided on the tractor for taking data related to the agricultural terrain; a processor unit embodied to take the data related to terrain conditions from said imaging unit and from said sensing unit; a memory unit associated with said processor unit; a communication unit for providing transferring the data, kept in said memory unit, to a remote server; a user interface provided in the vicinity of said steering wheel for providing informing of the user of the tractor associated in a manner connected to the processor unit; the processor unit is configured to realize the following steps:
To provide gaining meaning by the terrain images, taken from the imaging unit, by means of artificial intelligence based image sensing method,
To provide analyzing of the images which gained meaning and the data which are taken from the sensing unit by means of the artificial intelligence algorithm,
To provide making of soil analysis and to provide informing of the user by forming the digital twin of the marker line in accordance with the analysis result,
To provide detection of the obstacles, which exist in front of the tractor, in accordance with the analysis result,
To control operation of the drive element in accordance with the formed marker line and the detected obstacles,
To control operation of the planting module for realizing planting in a suitable manner to the distance entered by means of the user interface in accordance with the marker line,
To provide identification of the plants by means of the artificial intelligence algorithm for the processes after planting like fertilizing, agricultural spraying and hoeing,
To provide detection of the weeds among the identified plants,
To provide operation of the cleaning mode for providing cleaning of the terrain from the detected weeds,
To provide analyses like disease, water need, fertilizer need, distance measurement, number of plants per decare by forming digital twin of the cropland from the identified plants and to provide informing of the user,
To provide realization of the operation of the tractor in an autonomous manner for operation after planting like fertilizing, agricultural spraying and hoeing by the tractor in accordance with the identified plant order,
To provide recording of the data learnt by the artificial intelligence algorithm, the realized processes and collected and analyzed data to the memory unit,
To provide transfer of the data, kept in the memory unit, to said remote server by means of the communication unit,
To provide presenting of the data to the user visually by means of the user interface for informing the user,
To provide access to the data, related to the tractor, by a user who has access to the remote server and to provide realization of controls of the tractor in a remote manner.

Thus, the tractor fulfills its function autonomously in an independent manner from the driver.

In a possible embodiment of the present invention, a power supply is provided for meeting the energy requirement.

In another possible embodiment of the present invention, the sensing unit comprises an angle sensor for providing detection of the rotation angle of the tractor and a tilt sensor for providing detection of the slope of the tractor.

In another possible embodiment of the present invention, the processor unit is embodied to provide learning of the data beforehand by means of deep learning algorithm depending on the artificial intelligence algorithm and provide storing of the learnt data in the memory unit in order to be used later.

In another possible embodiment of the present invention, the processor unit is configured to provide formation of a new image from the images collected in the imaging unit and to provide formation of the digital twin thereof and to provide realization of analysis and meaning formation processes through this digital twin by means of artificial intelligence.

In another possible embodiment of the present invention, a user terminal, which is connected to the server, is provided.

In another possible embodiment of the present invention, the processor unit is configured to provide loading of the new artificial intelligence models and the updates by means of remote access to the server connected by means of the communication unit. Thus, the system renews itself continuously by means of the developing technology and stays updated.

### BRIEF DESCRIPTION OF THE DRAWINGS

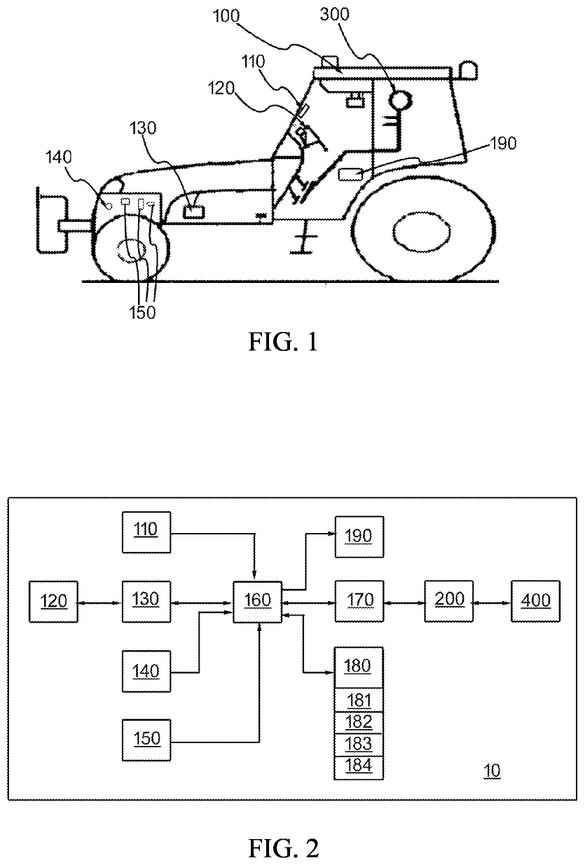

In FIG. 1, a representative view of the artificial intelligence based autonomous tractor system is given.

In FIG. 2, a representative view of the artificial intelligence based autonomous tractor system is given.

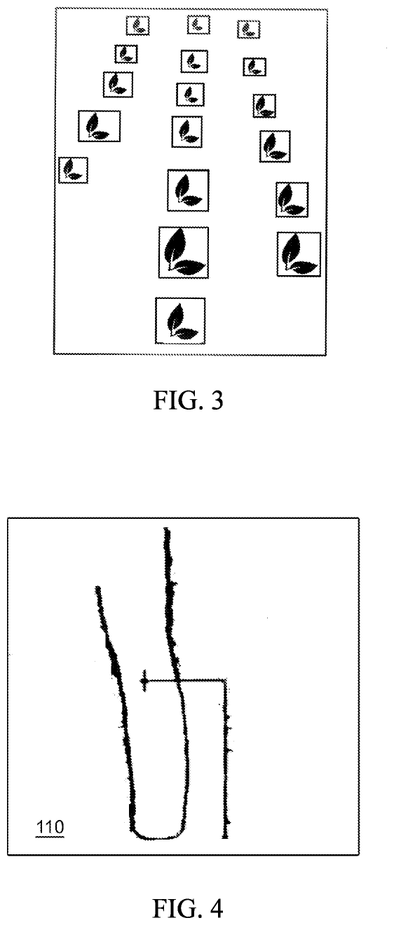

In FIG. 3, a representative view where an image, where the plants are marked which are detected by means of the plant recognition module provided to the artificial intelligence based autonomous tractor system, is presented to the user by means of the user interface is given.

In FIG. 4, a representative view where an image, where the marker line is formed which is determined by means of the marker line sensing module provided to the artificial intelligence based autonomous tractor system, is presented to the user by means of the user interface is given.

### REFERENCE NUMBERS IN THE FIGURES

10 Artificial intelligence based autonomous tractor system
100 Tractor
110 User interface
120 Steering wheel
130 Drive element
140 Imaging unit
150 Sensing unit
160 Processor unit
170 Communication unit
180 Memory unit
181 Obstacle sensing module
182 Plant identification module
183 Marker line sensing module
184 Plant shredding module
190 Power supply
200 Server
300 User
400 User terminal

### DETAILED DESCRIPTION OF THE EMBODIMENTS

In this detailed description, the subject matter is explained with references to examples without forming any restrictive effect only in order to make the subject more understandable.

The present invention relates to an autonomous tractor system (10) for use in agricultural areas and designed with an artificial intelligence based innovative architecture for providing autonomous movement of a tractor (100).

In FIG. 1, said tractor (100) comprises a steering wheel (120) which provides guidance of the tractor (100) to a predetermined direction. There is a drive element (130) embodied to move said steering wheel (120). In a possible embodiment of the invention, electro-hydraulic steering wheel manipulation module is used comprising an open cycle hydraulic circuit which provides guidance of the steering wheel, provided to the hydraulic system of the tractor as the drive element (130), to the predetermined direction by means of artificial intelligence algorithm. Said drive element (130) provides automatic adjustment of the direction of the steering wheel depending on the coming control signal. The drive element (130) is embodied in a manner connected to the steering wheel. There is an imaging unit (140) comprising pluralities of image elements placed in a manner providing taking image from the periphery of the tractor (100). Said imaging unit (140) provides imaging of the periphery of the tractor (100) and provides taking of the images of the terrain. In a possible embodiment of the present invention, as the imaging unit (140), pluralities of image sensors, cameras, etc. provided on the tractor are used. In order to provide detection of the terrain conditions, a sensing unit (150) comprising pluralities of sensors is provided in the tractor (100). Said sensing unit (150) comprises a tilt sensor for providing detection of the slope of the terrain placed to different positions of the tractor (100). The sensing unit (150) moreover comprises an angle sensor for providing detection of the rotation angle of the tractor (100). There is a user interface (110) which will enable the user (300) to realize data input and configured to inform the user (300) and placed to the position where the user (300) can visually trace in the vicinity of the steering wheel (120) and where the user can interact in an interactive and touch-sensitive manner. In a possible embodiment of the present invention, the user interface (110) can be a touch-screen, etc. By means of the user interface (110), the user is informed about conditions like the direction, speed of the tractor (100), before and after planting, fuel, fertilizing, agricultural spraying, etc. The user interface (110) screen is water-proof and has high resolution characteristics.

The autonomous tractor (100) system comprises a processor unit (160) embodied to provide reading of artificial intelligence based software which provides operation of the subject matter, and which provides realization of the read software commands. There is a memory unit (180) associated with said processor unit (160) and which stores said artificial intelligence based computer software. There is a communication unit (170) configured to provide realization of data exchange between the processor unit (160) and a remote server (200). In a possible embodiment of the present invention, a Wifi module, etc. is used as the communication unit (170). A remote user is connected to the server (200) by means of a user terminal (400), and access can be provided to the data. In a possible embodiment of the present invention, as the user terminal (400), there can be a mobile application, etc. provided to the mobile device like a smart phone, computer, tablet, etc. In a possible embodiment of the present invention, a cloud network is used as the server (200). Said artificial intelligence based computer software comprises pluralities of functional software modules formed by pluralities of software commands. When the command lines of said software modules are read by means of the processor unit (160), the processes which provide autonomous operation of the tractor (100) are realized. Said software modules comprise artificial intelligence models recorded to the memory unit (180) and which have been learned beforehand by means of deep learning and artificial intelligence algorithms. The processor unit (160) provides applying of the data, collected from the imaging unit (140) and from the sensing unit (150), as input to the artificial intelligence models. Said models are decision making systems which provide analyzing of data as a result of learning in a similar manner to human brain.

The processor unit provides taking images of the periphery of the tractor (100) instantaneously from the imaging unit (140). The taken images are processed by means of artificial intelligence based image sensing algorithm. A new image is formed from the processed images. The new image is presented to the user in the user interface (110) by means of the processor unit (160). Moreover, the image is recorded in the memory unit (180). The processor unit (160) moreover provides taking of the slope data of the agricultural terrain and the rotational angle data of the tractor (100) from the sensing unit (150). The processor unit (160) provides applying of the collected data as input to the artificial intelligence models kept in the memory unit (180). The artificial intelligence models provide analysis of the data. The processor unit (160) provides transfer of the signals to the related units in accordance with the analysis result.

The memory unit (180) comprises an obstacle sensing module (181) comprising software commands which provide sensing of the obstacles which exist in the periphery of the tractor (100) and read by means of the processor unit (160). The processor unit (160) provides analyzing of the collected data by means of the artificial intelligence model provided in the obstacle sensing module (181). The obstacles like human, animal, stone, watering well, etc., which exist in the periphery of the tractor (100), are detected in a probability-based manner in accordance with the software commands which exist in the obstacle sensing module (181). The obstacle sensing module (181) moreover comprises command lines which will provide identification of traffic signs, highway strips and traffic lamps, etc. The processor unit (160) provides detection of obstacles and traffic signs, which exist in the periphery of the tractor (100), in a probability-based manner by means of reading of the commands which exist in the obstacle sensing module (181). In case an obstacle is detected which exists in a manner forming an unfavorable condition in the periphery of the tractor (100) as a result of reading of the commands provided in the obstacle sensing module (181), the processor unit (160) provides stopping of the tractor (100) depending on the closeness of the obstacle to the tractor (100) and the speed of the tractor (100) or provides changing the direction of the tractor (100) by making a new route planning by the processor unit (160). In said condition, the closeness of the obstacle is determined in accordance with the probability condition. The determined closeness degree is processed onto the images taken from the imaging unit (140) and the new formed image is presented to the user by means of the user interface (110). In case the processor unit (160) detects that the closeness of the obstacle with respect to the tractor is more than a predetermined proportion, it provides stopping of the tractor (100). The processor unit (160) provides interrupting of the energy of the motor of the tractor (100) for stopping the tractor (100). In case the processor unit (160) detects that the closeness of the obstacle with respect to the tractor (100) is less than a predetermined proportion, it provides control of the drive element (130) and provides changing of the direction of the steering wheel (120). Thus, diverging of the tractor (100) from the obstacle is provided, and hitting is avoided. The processor unit (160) provides warning of the user about the detected obstacle and the position of the obstacle by means of the user interface (110). For said condition, a warning message is formed on the user interface (110) screen. The processor unit (160) moreover provides instantaneous recording of the processes, realized in case the obstacle sensing module (181) is read, to the memory unit (180).

The memory unit (180) comprises a marker line sensing module (183) including software commands read by the processor unit (160) and which provide determination of the route of the tractor (100). The processor unit (160) provides analyzing of the collected data by means of the artificial intelligence model provided in said marker line sensing module (183). In accordance with the software commands included by the marker line sensing module (183), the route where planting shall be realized is determined before planting in the agricultural terrain. The marker sensing module software commands moreover provide determination of the positions where planting shall be realized on the terrain and provides adjustment of suitable distance between the planting arches. Determination of the marker line provides determination of the route of the tractor (100). The processor unit (160) provides taking images of the periphery of the tractor (100) by means of the imaging unit (140). The taken images are sensed by the artificial intelligence based image sensing algorithm. A new image is formed comprising the digital twin of the marker line by means of the artificial intelligence algorithm from the sensed images and from the position data determined instantaneously by means of the image sensing algorithm, and the soil analysis is realized. The formed new image and the soil analysis are presented to the user by means of the user interface (110). The processor unit (160) controls operation of the drive element (130) in accordance with the marker line. The drive element (130) provides changing of the direction of the steering wheel (120) in accordance with the direction of the tractor (100). Thus, the tractor (100) is autonomously driven. The processor unit (160) provides recording of the new image, including the formed marker line and the direction of the tractor (100), to the memory unit (180) instantaneously.

The memory unit (180) comprises a plant identification module comprising software commands read by the processor unit (160) and which provide detection of plant types in the periphery of the tractor (100). The processor unit (160) provides analyzing of the collected data by means of the artificial intelligence model provided in said plant identification module (182). Plants, which exist on the agricultural terrain, are identified in accordance with the software commands of the plant identification module (182). Thus, weeds which exist on the agricultural field can be detected. The processor unit (160) provides collection of the images from the image unit. The taken images are sensed by the artificial intelligence based image sensing algorithm. Plants on the image are detected from the taken images by means of the artificial intelligence algorithm. The digital twin of the terrain is formed from the detected plants and analyses are made like disease, water requirement, fertilizer requirement, distance measurement, number of plants which fall per decare. The detected plants and analysis results are processed on the image and a new image is formed. The processor unit (160) provides presenting of the new formed image to the user by means of the user interface (110). The processor unit (160) provides instantaneous recording of the new images, where the formed weed types are marked, to the memory unit (180).

The memory unit comprises a plant shredding module (184) comprising the software commands read by means of the processor unit (160) and which provides shredding of weed types, which exist in the vicinity of the tractor (100), by means of hoeing process. The processor unit (160) provides detection of the plant types, which exist in the vicinity of the tractor (100), by means of reading of the software commands provided in the plant identification module. Weed types are detected from the detected plant types. Hoeing process has to be realized for providing cleaning of the detected weed types from the agricultural terrain. In order to realize the hoeing process, the artificial intelligence based software, provided to the plant shredding module (184) and kept in the memory unit (180), is read by means of the processor unit (160). As said software is read, the hoeing elements are operated by means of the processor unit (160). In this case, the agricultural field is cleaned from weeds. The processor unit (160) provides informing of the user in relation to the hoeing process by means of the user interface (110). The processor unit (160) moreover provides instantaneous recording of the information, presented to the user, in the memory unit (180).

The processor unit provides transferring of all collected and analyzed data to a server (200), which exists at a far location, by means of the communication unit (170). The data, sent by means of the communication unit (170), are temporarily stored in the server (200). By means of a user terminal (400) connected to the server (200), the access of a user, which exists at a far location, to the data becomes possible. The user, which exists at a far location, provides loading of new artificial intelligence models to the server (200) by means of the user terminal (400). The processor unit (160) provides taking of the loaded artificial intelligence models, from the server (200) by means of the communication unit (170). The processor unit (160) analyzes the taken data and provides storage of said data in the memory unit (180) in order to be used afterwards. Thus, new artificial intelligence models are loaded to the autonomous tractor (100) and new modules are formed. This condition provides the system to always stay updated. There is a power supply (190) for providing energy to the artificial intelligence based autonomous tractor (100) system (10). The processor unit provides operation of the tractor in an autonomous manner in a manner realizing operations after planting like fertilizing, agricultural spraying and hoeing in accordance with the predefined plant sequence recorded in the memory unit.

An exemplary operation scenario of the invention is described below;

A user autonomously uses the artificial intelligence based autonomous tractor (100) in a field. The user first of all provides starting of the autonomous operation process by means of the user interface (110) provided in the vicinity of the steering wheel (120). As the tractor (100) is passed to the autonomous operation mode, first of all, the images are taken from the imaging unit (140) placed on the tractor (100). The taken images are gained meaning by the artificial intelligence based image sensing algorithm by means of the processor unit (160). Gaining meaning by the images means the reading and sensing of the images, and detecting the objects which exist on the image, and forming the most optimum route formed by means of artificial intelligence software through the digital twin formed after said detection process. New information is processed on the images, which have gained meaning, by means of the processor unit (160) and are presented to the user on the user interface (110). Thus, the speed of the tractor (100) is adjusted according to the slope thereof. The processor unit (160) moreover provides detection of the angle of the steering wheel (120) of the tractor (100) from the angle sensor. Thus, the direction of the tractor (100) is determined.

The processor unit provides reading of the software commands stored in the memory unit (180). One of the software commands kept in the memory unit (180) is the marker line sensing module (183). The software commands provided in the marker line sensing (183) module provides formation of the marker line for providing determination of the route of the tractor (100). The marker line is a route formed for providing planting of the tractor (100) in a firm manner. The tractor (100) provides realization of planting at predetermined intervals along the formed marker line. The processor unit (160) provides reading of the software provided in the marker line sensing module (183) and provides operation of the planting module in accordance with the planting distance information taken from the user interface (110). Thus, planting is realized at determined distance. The processor unit (160) provides controlling of the operation of the drive element (130) in accordance with the formed marker line and the data received from the sensing unit (150) and provides guidance of the steering wheel (120) with respect to the marker line. The processor unit (160) moreover provides processing of the marker line onto the taken images and provides presenting of the formed new image to the user by means of the user interface (110). On the image presented on the user interface (110), there are visual elements which show the direction of the steering wheel (120) and the marker line. The marker sensing module moreover provides realization of the soil analysis and provides information to the user by means of the user interface. Thus, the user is informed. The processor unit (160) moreover provides keeping the time data of the formed route in the memory unit (180).

One of the software commands which exist in the memory unit is the obstacle sensing module (181). The processor unit (160) provides reading of artificial intelligence based software commands which exist in the obstacle sensing module (181). Said software provides detection of the obstacles provided in the vicinity of the tractor (100). The processor unit (160) provides detection of the obstacles which exist in the images in case the images, taken from the imaging unit (140), are given as input to the artificial intelligence based software module. The obstacle sensing module (181) provides stopping of the tractor (100) by means of the processor unit (160) depending on software commands or provides changing of the direction of the tractor by realizing a new route planning. The processor unit (160) provides operation of the drive element (130) and provides changing the direction of the steering wheel (120) in case it is detected that the obstacle, which exists in the vicinity of the tractor (100), is far from a predetermined distance. For instance, in case it is detected that there are objects like a stone, etc. exist far from the predetermined distance in the route of the tractor (100), the route of the tractor (100) must be changed. Process is realized onto the image where said obstacle and direction change condition are taken and said image is presented to the user by means of the user interface (110). The user can display an image, which shows the position of the obstacle, the distance with respect to the tractor (100) and the tractor (100) rotation direction, through the user interface (110). In a possible embodiment of the present invention, the user can be informed in an audible manner by means of the user interface (110). The processor unit (160) provides braking for stopping the tractor (100) in case the processor unit (160) detects that the distance of the obstacle, which exists in the vicinity of the tractor (100), is less than the predetermined distance. Depending on said braking, any hitting condition is prevented. For instance, braking is realized against the presence of an animal or a human, etc. which exists on the route. Said braking condition and said obstacle are processed onto the taken images and are presented to the user by means of the user interface (110). The user is informed about stopping of the tractor (100). In a possible embodiment of the present invention, the user can also be informed in an audible manner by means of the user interface (110). Thus, the tractor (100) senses the obstacles and stopped or the route of the tractor (100) is changed.

Another one of the software commands kept in the memory unit (180) is the plant identification module (182). In order to be able to realize the hoeing process, the plants which exist on the field must be detected. The detected plants are classified as weeds and plants which are not weeds. Thus, while hoeing process is being realized, only weeds are cleaned from the fields. The plant identification module (182) provides identification of the plants by means of the artificial intelligence algorithm. The processor unit (160) provides taking of the images of the vicinity of the tractor (100) primarily of the imaging unit (140). The processor unit (160) provides detection of plants and weeds through the images by inputting the taken images to the artificial intelligence based software model provided to the plant identification module (182). Digital twin of the field is formed from the detected plants, and analyses are made like disease, water need, fertilizer need, distance measurement, number of plants per decare. The processor unit (160) provides processing of the detected weeds and analysis results on the image and provides presenting thereof to the user by means of the user interface (110). On the user interface (110) screen, the weeds among the plants which exist in the vicinity of the tractor (100) are displayed in a different color tone, and thereby the user is informed about the weeds.

The processor unit (160) provides detection of weeds through the image by reading the software commands provided in the plant identification module (182). In order to provide removal of the detected weeds from the field, the software commands provided to the plant shredding module (184) are read by the processor unit (160). The processor unit (160) provides realization of the hoeing process by reading software commands provided in the plant shredding module (184). For the hoeing process, operation of the cleaning modules provided to the tractor (100) is provided. The cleaning module is one of the additional parts provided to the tractor (100) which provides realization of the hoeing process. The processor unit (160) provides informing of the user by means of the user interface (110) for the hoeing process.

The processor unit (160) provides transfer of data to a user, which is at a far location, by means of the communication unit (170). The communication unit (170) provides transfer of the data, received from the processor unit (160), to a server (200). The data transferred to the server (200) is stored in a temporary manner. A user which is far from the tractor (100) is connected to the server (200) by means of a user terminal (400) and can provide access to the data. The user terminal (400) can be a mobile application provided to a mobile device. The user can provide remote control of the tractor (100) by means of mobile device. The user, which is at a far location, moreover provides transfer of the new artificial intelligence models to the server (200) by means of the user terminal (400). The processor unit (160) can access the new artificial intelligence models loaded to the server (200) by means of the communication unit (170). The processor unit (160) provides analyzing by taking new artificial intelligence models from the server (200) and provides recording thereof in the memory unit (180) for use afterwards as a result of analysis.

In an exemplary embodiment of the invention, in case a farmer desires to use his tractor (100) autonomously, he activates a start button provided on a screen provided in the vicinity of the steering wheel (120). As the autonomous driving mode is activated, the processor unit (160) first of all provides determination of the route of the tractor (100). Images are instantaneously taken from the cameras provided in the vicinity of the tractor (100). The image of the formed route is processed on the images. Said route is a marker line formed on the image. Depending on the marker line, the farmer provides selecting of the distance, where planting shall be realized between the plants, through the screen. In accordance with the formed marker line, the steering wheel (120) is guided by means of the electro-hydraulic steering wheel manipulation. The plants are planted in accordance with the distance determined during the movement of the tractor (100) with respect to the marker line. The movement direction of the steering wheel (120), the marker line and the planting process are processed on the taken images and are presented to the user by means of the screen. In case a stone, an obstacle, etc. objects are detected at the front during autonomous driving of the tractor (100), the direction of the tractor (100) is changed and the tractor (100) passes by the side thereof without hitting the obstacle or the tractor is stopped by realizing braking depending on the distance of the obstacle with respect to the tractor (100). Thus, during autonomous driving, the risk of hitting of the tractor (100) to the obstacles which may occur is eliminated. Said obstacles are processed to the taken images in a probability-based manner and are presented to the farmer through the screen.

In case the planting process is completed, processes after planting are realized in the field. In this case, in order to realize processes after planting during autonomous driving, first of all, the weeds which exist on the field must be detected through the images taken from the cameras. The detected weeds are marked on the images and are presented to the user through the screen. The detected weeds are removed from the field by operating the cleaning module. The farmer is informed through the screen during all processes. Moreover, in case the farmer exists at a position which is far from the tractor (100), all processes realized during an autonomous driving are transferred to the farmer by means of an application provided to the telephone of the farmer. Thus, the farmer can control his tractor remotely and is informed about the processes made during autonomous driving and about the driving condition. When processes made for autonomous driving is completed, the operation of the motor is stopped and thereby the tractor (100) is stopped.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. An artificial intelligence based autonomous tractor system for use in agricultural areas, comprising a tractor, a steering wheel for providing guidance of the tractor to a determined direction, and a drive element embodied for electro-hydraulic steering wheel manipulation and comprising an open cycle hydraulic circuit which provides guidance of the steering wheel to the determined direction for providing movement of the steering wheel, in order to provide autonomous movement of the tractor, wherein
the artificial intelligence based autonomous tractor system further comprises:
an imaging unit for capturing images from a front of the tractor;
a sensing unit provided on the tractor for taking data related to an agricultural terrain;
a processor unit embodied to take data related to terrain conditions from the imaging unit and from the sensing unit;
a memory unit associated with the processor unit;
a communication unit for providing transferring the data, kept in the memory unit, to a remote server; and
a user interface provided in a vicinity of the steering wheel for providing informing of a user of the tractor associated in a manner connected to the processor unit;
wherein the processor unit is configured to realize the following steps:
providing gaining meaning by terrain images, taken from the imaging unit, by means of an artificial intelligence based image sensing method,
providing analyzing of the images which gained meaning and the data which are taken from the sensing unit by an artificial intelligence algorithm,
providing making of soil analysis and providing informing of the user by forming a digital twin of a marker line in accordance with an analysis result,
providing detection of obstacles, which exist in front of the tractor, in accordance with the analysis result,
controlling operation of the drive element in accordance with the marker line and the detected obstacles,
controlling operation of a planting module for realizing planting in a suitable manner to a distance entered by means of the user interface (110) in accordance with the marker line,
providing identification of the plants by the artificial intelligence algorithm for the processes after planting like fertilizing, agricultural spraying and hoeing,
providing detection of weeds among the plants,
providing operation of a cleaning mode for providing cleaning of the terrain from the weeds,
providing analyses like disease, water need, fertilizer need, distance measurement, number of plants per decare by forming digital twin of cropland from the plants and providing informing of the user,
providing realization of an operation of the tractor in an autonomous manner for operation after planting like fertilizing, agricultural spraying and hoeing by the tractor in accordance with an identified plant order,
providing recording of the data learnt by the artificial intelligence algorithm, the realized processes and collected and analyzed data to the memory unit,
providing transfer of the data, kept in the memory unit, to the remote server by the communication unit,
providing presenting of the data to the user visually by the user interface for informing the user, and
providing access to the data, related to the tractor, by a user who has access to the remote server and providing realization of controls of the tractor in a remote manner.

2. The artificial intelligence based autonomous tractor system according to claim 1, wherein a power supply is provided for meeting an energy requirement.

3. The artificial intelligence based autonomous tractor system according to claim 1, wherein the sensing unit comprises an angle sensor for providing detection of a rotation angle of the tractor and a tilt sensor for providing detection of a slope of the tractor.

4. The artificial intelligence based autonomous tractor system according to claim 1, wherein the processor unit is embodied to provide learning of the data beforehand by a deep learning algorithm depending on the artificial intelligence algorithm and provide storing of the learnt data in the memory unit in order to be used later.

5. The artificial intelligence based autonomous tractor system according to claim 1, wherein the processor unit is configured to provide formation of a new image from the images collected in the imaging unit and to provide realization of the processes through the formed image.

6. The artificial intelligence based autonomous tractor system according to claim 1, wherein a user terminal is connected to the server.

7. The artificial intelligence based autonomous tractor system according to claim 1, wherein the processor unit is configured to provide loading of the new artificial intelligence models and updates by remote access to the server connected by the communication unit.
